(19) United States
(12) Patent Application Publication
(10) Pub. No.: US 2006/0023123 A1
(43) Pub. Date: Feb. 2, 2006

(54) DIGITAL TV RECEIVER WITH ANTENNA DIVERSITY

(76) Inventors: Kuang-Yu Yen, Tai-Chung City (TW); Cheng-Yi Huang, I-Lan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,205

(22) Filed: Jul. 27, 2005

(30) Foreign Application Priority Data
Jul. 29, 2004 (TW) 093122744

(51) Int. Cl. H04N 5/268; H04N 5/44

(52) U.S. Cl. 348/705; 348/725

(57) ABSTRACT

A digital television (TV) receiver includes a switching unit for selecting one of a plurality of signals so the digital TV receiver utilizes an antenna to which the selected signal corresponds. In an embodiment, the digital TV receiver further includes a VSB demodulator for synthesizing a plurality of digital signals corresponding to a plurality of antennas to generate a synthesized signal and for demodulating the synthesized signal to generate a demodulated signal.

### BACKGROUND OF THE INVENTION

1. Field of the Invention

The present invention relates to a digital television (TV) system, and more particularly, to a digital TV receiver.

2. Description of the Prior Art

When a digital TV signal such as a signal complying with Advanced Television Systems Committee (ATSC) specifications is transmitted in the air, the multi-path effect introduces an inter-symbol interference (ISI) phenomenon of the signal. An ATSC receiver of the art includes a single antenna; one solution of the problem mentioned above for the ATSC receiver is design revision of the backend circuit (e.g. involvement with an equalizer) for solving the multi-path effect. Components and operation principles of the ATSC receiver are well known in the art and therefore are not explained in detail here.

As the location of the main path of wireless signals may vary when the antenna is moved or there is any person or object moving nearby, the ATSC receiver needs a time period for correcting internal parameters thereof to maintain the performance of the ATSC receiver under variations of the main path. In a worst-case scenario, the ATSC receiver even needs to relock. While the ATSC receiver is correcting the internal parameters thereof or relocking, images of the program being watched by the user will be interrupted. When the antenna is an indoor antenna, the problem mentioned above becomes even worse.

### SUMMARY OF THE INVENTION

It is therefore one of objectives of the present invention to provide a digital television receiver with antenna diversity.

It is therefore one of objectives of the present invention to provide a digital television receiver with antenna diversity. The digital television can reduce the phenomenon where images of the program being watched by the user are interrupted.

It is therefore one of objectives of the present invention to provide a digital television receiver with antenna diversity. The digital television receiver chooses the time of a field sync symbol of the digital TV signal for performing the antenna switches.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a digital TV receiver according to a first embodiment of the present invention.

FIG. 2 is a diagram of a digital TV receiver according to a second embodiment of the present invention.

FIG. 3 is a diagram of an embodiment of the vestigial-sideband (VSB) demodulator according to the present invention.

FIG. 4 is a diagram of a digital TV receiver according to a third embodiment of the present invention.

FIG. 5 is a diagram of a digital TV receiver according to a fourth embodiment of the present invention.

FIG. 6 is a diagram of a digital TV receiver according to a fifth embodiment of the present invention.

### DETAILED DESCRIPTION

Although the digital television receiver in the following embodiments is described in accordance with ATSC specifications, this is not a limitation of the present invention.

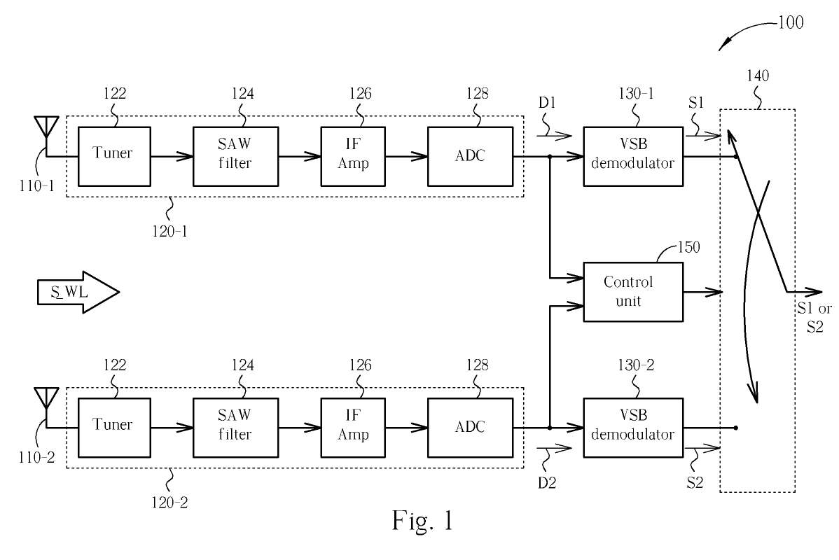

FIG. 1 is a diagram of a digital TV receiver 100 according to a first embodiment of this invention. The receiver 100 includes: a plurality of antennas 110-1 and 110-2, a plurality of signal processing modules 120-1 and 120-2, a plurality of vestigial-sideband (VSB) demodulators 130-1 and 130-2, a switching unit 140, and a control unit 150. In this embodiment, both signal processing modules 120-1 and 120-2 include a tuner 122, a surface acoustic wave (SAW) filter 124, an intermediate-frequency amplifier (IF Amp) 126, and an ADC 128. All of the components 122, 124, 126, and 128 are well known in the art, and therefore the implementation of these components 122, 124, 126, and 128 and operations thereof are not explained in detail here. Usually, the signal processing modules 120-1 and 120-2 are utilized for performing proper processing on the signals received from the antennas before demodulation, so various component configurations are applicable to the signal processing modules according to another embodiment of the present invention. Therefore, the exact number of components within the signal processing modules may be varied for implementation according to the present invention.

The antennas 110-1 and 110-2 are utilized for receiving a wireless signal S_WL. The signal processing module 120-1 generates a digital signal D1 according to the wireless signal S_WL received by the antenna 110-1, and the VSB demodulator 130-1 demodulates the digital signal D1 to generate a demodulated signal S1. Similarly, the signal processing module 120-2 generates a digital signal D2 and the VSB demodulator 130-2 generates a demodulated signal S2. The switching unit 140 selects one of the demodulated signals S1 and S2 generated by the VSB demodulators 130-1 and 130-2 respectively.

The control unit 150 of this embodiment controls the switching unit 140 according to the power of the digital signals D1 and D2 generated by the signal processing modules 120-1 and 120-2. When the power of the digital signal D2 is greater than that of the digital signal D1, the control unit 150 controls the switching unit 140 to select the demodulated signal S2 as an output signal of the digital TV receiver 100. Similarly, when the power of the digital signal D1 is greater than the power of the digital signal D2, the control unit 150 controls the switching unit 140 to select the demodulated signal S1 as the output signal of the digital TV receiver 100. Therefore, utilizing the digital TV receiver 100 described in this embodiment can greatly reduce the phenomenon where images of the program being watched by the user are interrupted. It is noted that the control unit in a variation of this embodiment may control the switching unit according to other signals corresponding to an upper/lower path respectively such as the upper/lower half of the circuits shown in FIG. 1.

In a preferred embodiment, the control unit 150 chooses the time of field sync symbol of the digital TV signal for performing the switching actions. In this manner, unwanted influence on images of the program, which are probably due to performing the switching actions, can be reduced. Of course, as is well known in the art, the timing of the switching actions mentioned above is determined as an implementation choice, which is not a limitation of the present invention.

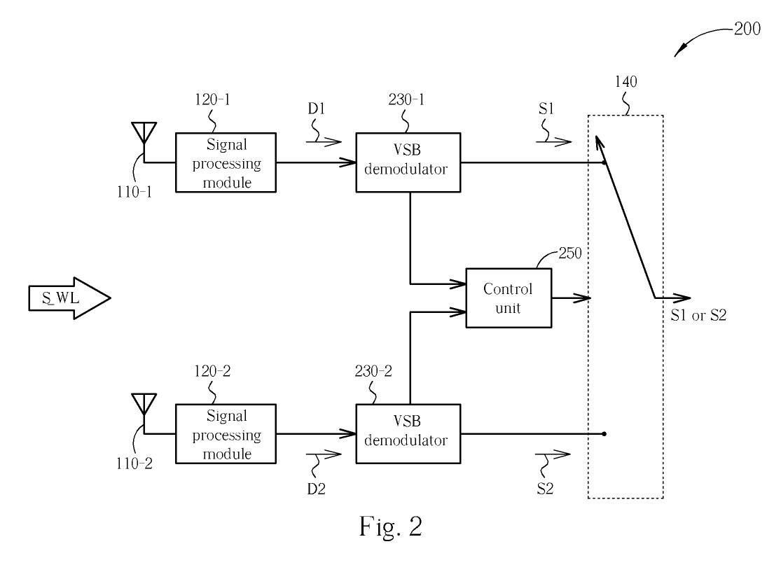

FIG. 2 is a diagram of a digital TV receiver 200 according to a second embodiment of the present invention. The digital TV receiver 200 is similar to the digital TV receiver 100 shown in FIG. 1. In the second embodiment, The control unit 250 controls the switching unit 140 according to signals generated by the VSB demodulators 230-1 and 230-2 to select a preferred demodulated signal S1 or S2.

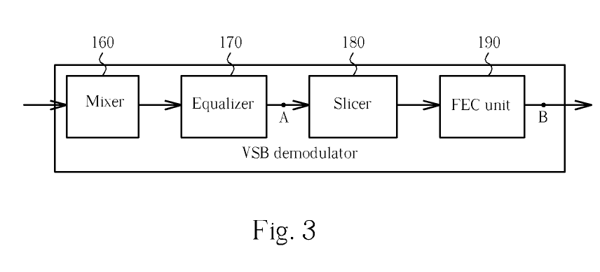

FIG. 3 is a diagram of an embodiment of the Vestigial-Sideband (VSB) demodulator of the invention. As well known in the art, both VSB demodulators usually comprise a mixer 160, an equalizer 170, a slicer 180, and a Feed-forward Error Correction (FEC) unit 190. The control unit 250 controls the switching unit 140 by various ways such as comparing the signal to noise ratio (SNR) of signals at the output end of the equalizer 170 (i.e. the node A), or comparing the bit error rate (BER) of signals at the output end of the FEC correction unit 190 (i.e. the node B). As a result, the switching unit 140 is capable of selecting the better one out of the demodulated signals S1 and S2. In this embodiment, the FEC correction unit 190 can be implemented utilizing Reed-Solomon (RS) code or Viterbi code. The implementation of the VSB demodulator is well known in the art and therefore not explained in detail here.

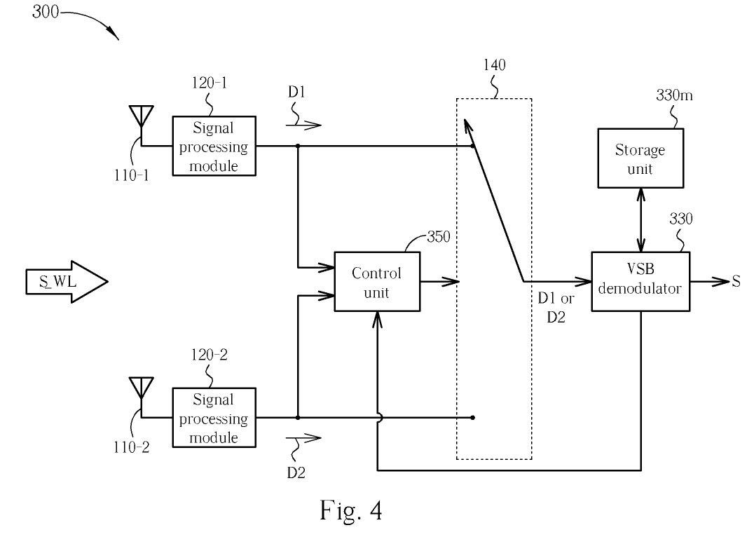

FIG. 4 is a diagram of a digital TV receiver 300 according to a third embodiment of the present invention. In the third embodiment, the switching unit 140 of the receiver 300 is located between the signal processing modules 120-1 and 120-2 and the VSB demodulator 330, so the switching unit 140 is utilized for selecting one of the digital signals D1 and D2 generated by the signal processing modules 120-1 and 120-2 respectively according to control of the control unit 350, and sending the selected digital signal D1 or D2 to the VSB demodulator 330. The digital TV receiver 300 further comprises a storage unit 330m coupled to the VSB demodulator 330, for storing two sets of parameters of the VSB demodulator 330. The two sets of parameters respectively correspond to the signal processing module 120-1 and the signal processing module 120-2 in FIG. 3. In other words, the VSB demodulator 330 utilizes one out of the two sets of parameters to perform operations when the switching unit 140 switches to the signal processing module 120-1, and utilizes the other one out of the two sets of parameters to perform operations when the switching unit 140 switches to the signal processing module 120-2. As a result, the VSB demodulator 330 is capable of training the two sets of parameters to match up with the actions of the signal processing modules 120-1 and 120-2 respectively. In the embodiment, the control unit 350 controls the switching unit 140 can be implemented by comparing the power of the two digital signals D1 and D2, or according to the signal generated by the VSB demodulator 330.

In the third embodiment, when the control unit 350 controls the switching unit 140 according to characteristics of the signal generated by the VSB demodulator 330, e.g. the SNR at the output end of the equalizer 170 or the BER at the output end of the FEC correction unit 190. Triggering the switching actions can be implemented by comparing the value representing the characteristic of the signal derived from the VSB demodulator 330 with a threshold value, i.e. when the SNR or the BER is greater than the threshold value then switching the connection of the switching unit 140 to the other path will occur.

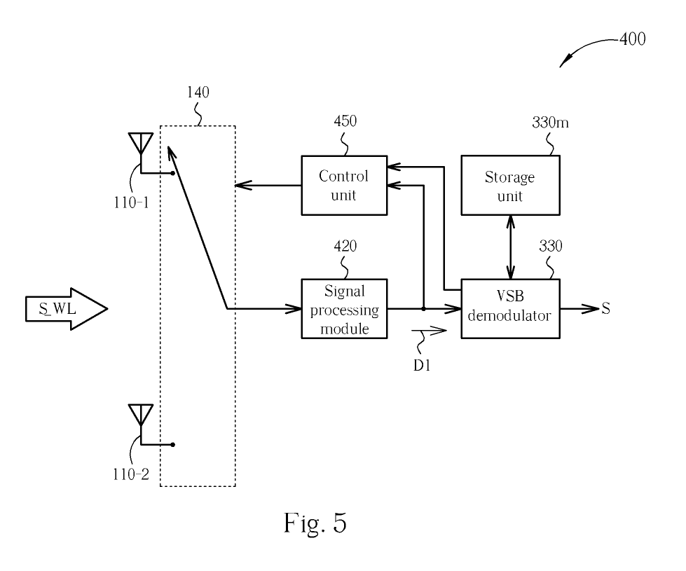

FIG. 5 is a diagram of a digital TV receiver 400 according to a fourth embodiment of the present invention. In the digital TV receiver 400, the switching unit 140 is located between the antennas 110-1 and 110-2 and the signal processing module 420, so the switching unit 140 is utilized for selecting one of the signals respectively received by the antennas 110-1 and 110-2 according to control of the control unit 450, and sending the selected signal to the signal processing module 420. The signal processing module 420 then sends the digital signal D1 derived after processing to the VSB demodulator 330. Here the signal processing module 420, the VSB demodulator 330, and the storage unit 330m are similar to those described in FIG. 4. As mentioned, the mechanism where the control unit 450 controls the switching unit 140 can be implemented according to characteristics of the digital signal D1 outputted by the signal processing module 420, or according to characteristics of the signal generated by the VSB demodulator 330. In this embodiment, while located next to the switching unit 140, the combination of the signal processing module 420 and the VSB demodulator 330 only forms a path, so the method of comparing a signal with a threshold as mentioned above is utilized for implementing the digital TV receiver 400 since the method of comparing two signals with each other is not applicable.

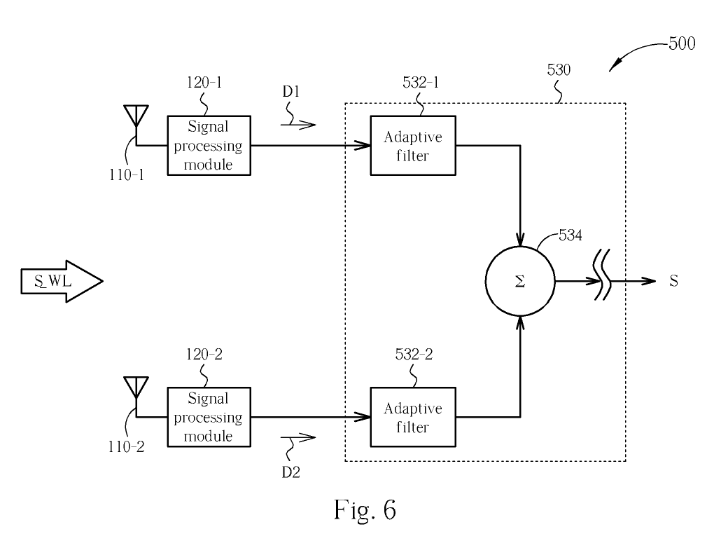

FIG. 6 is a diagram of a digital TV receiver 500 according to a fifth embodiment of the present invention. In this embodiment, the digital TV receiver 500 includes a VSB demodulator 530 coupled to the signal processing modules 120-1 and 120-2 for synthesizing the digital signals D1 and D2 to generate a synthesized signal, and demodulating the synthesized signal to generate a demodulated signal S. The latter stage in the VSB demodulator 530 is the same as the architecture in the VSB demodulator shown in FIG. 3, so the latter stage is only drawn with an ellipsis notation in FIG. 5 and not explained again here. The former stage of the VSB demodulator 530 (synthesizing module) includes: a plurality of adaptive filters 532-1 and 532-2 respectively coupled to the signal processing modules 120-1 and 120-2 for filtering the digital signals D1 and D2, respectively; and a synthesizing unit 534 coupled to the adaptive filters 532-1 and 532-2 for synthesizing the filtered digital signals respectively outputted by the adaptive filters 532-1 and 532-2 to generate the synthesized signal S. The VSB demodulator 530 utilizes the adaptive parameters in the adaptive filters 532-1 and 532-2 to adjust the phase between the digital signals D1 and D2, so the magnitude of the output signal of the synthesizing unit 534 can be optimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital television (TV) receiver comprising:
a plurality of antennas, each antenna being utilized for receiving a wireless signal;
a plurality of signal processing modules respectively coupled to the antennas, each signal processing module being utilized for generating a digital signal according to a corresponding wireless signal;
a plurality of demodulators respectively coupled to the signal processing modules, each
demodulator being utilized for demodulating a corresponding digital signal to generate a demodulated signal; and
a switching unit coupled to the demodulators for selecting one of the demodulated signals generated by the demodulators.

2. The digital TV receiver of claim 1 complying with Advanced Television Systems Committee (ATSC) specifications.

3. The digital TV receiver of claim 1, further comprising:
a control unit for controlling the switching unit according to the power of the digital signals generated by the signal processing modules.

4. The digital TV receiver of claim 1, wherein the switching unit is controlled according to a signal to noise ratio (SNR) and a bit error rate (BER) of the digital signals.

5. The digital TV receiver of claim 1, wherein the switching unit is controlled within the time interval of a field sync symbol of the wireless signal.

6. A digital television (TV) receiver comprising:
a plurality of antennas, each antenna being utilized for receiving a wireless signal;
a plurality of signal processing modules respectively coupled to the antennas, each signal processing module being utilized for generating a digital signal according to a corresponding wireless signal;
a first circuit coupled to the signal processing modules for receiving the digital signals generated by the signal processing modules and outputting a first signal comprising at least one of the digital signals; and
a demodulator for demodulating the first signal to generate a demodulated signal.

7. The digital TV receiver of claim 6 complying with Advanced Television Systems Committee (ATSC) specifications.

8. The digital TV receiver of claim 6, wherein the first circuit is a switching unit and the switching unit selects one of the digital signals to output the first signal.

9. The digital TV receiver of claim 8, further comprising:
a control unit for controlling the switching unit according to the power of the digital signals generated by the signal processing modules.

10. The digital TV receiver of claim 8, wherein the switching unit is controlled according to at least one of a signal to noise ratio (SNR) and a bit error rate (BER) of the digital signals.

11. The digital TV receiver of claim 8, wherein the switching unit is controlled within the time interval of a field sync symbol of the wireless signal.

12. The digital TV receiver of claim 6, wherein the first circuit is a synthesizing module, and the synthesizing module is used for synthesizing the digital signals generated by the signal processing modules to generate the first signal.

13. The digital TV receiver of claim 12, wherein the synthesizing module comprises:
a plurality of adaptive filters respectively coupled to the signal processing modules, each adaptive filter being utilized for filtering the digital signal; and
a synthesizing unit coupled to the adaptive filters for synthesizing the filtered signals to generate the first signal.

14. A digital television (TV) receiver comprising:
a plurality of antennas, each antenna being utilized for receiving a wireless signal;
a switching unit coupled to the antennas for selecting one of the wireless signals received by the antennas;
a signal processing module coupled to the switching unit for generating a digital signal according to the selected wireless signal; and
a demodulator coupled to the signal processing module for demodulating the digital signal to generate a demodulated signal.

15. The digital TV receiver of claim 14, complying with Advanced Television Systems Committee (ATSC) specifications.

16. The digital TV receiver of claim 14, wherein the signal processing module comprises:
a tuner coupled to the switching unit for tuning the selected wireless signal to generate a first signal;
a surface acoustic wave filter coupled to the tuner for filtering the first signal;
an intermediate-frequency amplifier coupled to the SAW filter for amplifying the first signal; and
an analog-to-digital converter coupled to the IF Amp for performing analog-to-digital conversion according to the first signal to generate the digital signal.

17. The digital TV receiver of claim 14, wherein the switching unit is controlled according to the power of the digital signal generated by the signal processing module.

18. The digital TV receiver of claim 14, wherein the switching unit is controlled according to at least one of a signal to noise ratio (SNR) and a bit error rate (BER) of the wireless signal.

19. The digital TV receiver of claim 14, wherein the switching unit is controlled within the time interval of a field sync symbol of the wireless signal.

20. The digital TV receiver of claim 14, further comprising:
a storage unit coupled to the demodulator for storing a plurality of sets of parameters,
wherein each set of parameters corresponds to one of the wireless signals.
